(19) United States
(12) Patent Application Publication
(10) Pub. No.: US 2005/0160083 A1
(43) Pub. Date: Jul. 21, 2005

(54) User-specific vertical search

(75) Inventor: Evan Robinson, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yahoo! Inc., Sunnyvale, CA (US)

(21) Appl. No.: 10/881,730

(22) Filed: Jun. 29, 2004

Related U.S. Application Data
(60) Provisional application No. 60/537,383, filed on Jan. 16, 2004.

(51) Int. Cl. G06F 7/00

(52) U.S. Cl. 707/3

(57) ABSTRACT

Techniques for performing user-specific searches are provided. A search engine receives a search query and performs processing to determine whether a user-specific search is indicated. If the search engine so determines, user-specific data is searched using user identity information to generate user-specific search results specific to the user identified by the user identity. Accordingly, the search results include information that is specific to the user determined from the user identity associated with the search query.

### CROSS-REFERENCES TO RELATED APPLICATIONS

This application claims the benefit of the filing date of U.S. Provisional Patent Application No. 60/537,383, filed Jan. 16, 2004 (Atty Docket No. 017887-013300US), which is incorporated by reference in its entirety for all purposes.

### BACKGROUND OF THE INVENTION

The present invention generally relates to content retrieval and more specifically to content retrieval from data including personal information for a user.

With the advent of the Internet, search engines have become useful tools for finding relevant information. Users typically enter a search query and a search engine determines content that is considered to be relevant to the query. The content that is searched is typically content that is accessible to all users (e.g., content on the Internet) or content specific to a search company. Content specific to a search may be content maintained by a particular entity, such as the content maintained by Yahoo! or content maintained (or not) by intermediate entities, such as contents available over the Internet in the form of web pages.

In both cases, the search that is run is generic. The search is generic in that the same content is searched for all users who submit queries. Thus, no matter who the user that submitted the search is, the user receives the most relevant content for the search query from the generic content.

### BRIEF SUMMARY OF THE INVENTION

In one embodiment, a method for performing a user-specific search is provided. A search engine receives a search query and performs processing to determine whether a user-specific search is indicated. If the search engine so determines, user-specific data is searched using user identity information to generate user-specific search results specific to the user identified by the user identity. Accordingly, the search results include information that is specific to the user determined from the user identity associated with the search query.

In one embodiment, a method for performing a personalized search is provided. The method comprises: receiving a search query; determining a user identity associated with the search query, wherein a user-specific search includes a search of information specific to a user identified by the user identity; determining if a user-specific search should be performed; performing a search using the search query with user identity information to generate user-specific search results specific to the user identified by the user identity, wherein the user-specific search results include information that is specific to the user identified by the user identity associated with the received search query.

In another embodiment, a method for performing a search is provided. The method comprises: receiving a search query from an entity; determining if a search using information specific to the entity should be performed; determining information that is specific to the entity associated with the search query; searching the determined information using the search query to generate search results that include at least a part of the determined information; and outputting the determined search results.

In yet another embodiment, a search apparatus configured to perform a personalized search is provided. The apparatus comprises: one or more search engines; one or more corpora of information, wherein user-specific information is included in the one or more corpora of information; a search server configured to receive a search query, the search server comprising: a search determiner configured to determine if a personalized search of user-specific information should be performed; a search engine determiner configured to determine a search engine in the one or more search engines to perform the personalized search, wherein the search engine is configured to determine the user-specific information for the entity in a corpus of the one or more corpora and to perform a search using the search query with the determined user-specific information to generate user-specific search results.

A further understanding of the nature and the advantages of the inventions disclosed herein may be realized by reference of the remaining portions of the specification and the attached drawings.

### BRIEF DESCRIPTION OF THE DRAWINGS

FIG. 1 illustrates a general overview of an information retrieval and communication network including a client system according to an embodiment of the present invention.

FIG. 2 depicts various search engines and corpora that may be included in embodiments of the present invention.

FIG. 3 depicts an embodiment of search server according to embodiments of the present invention.

FIG. 4 depicts a block diagram of elements that might be used to generate a response to a query according to one embodiment of the present invention.

FIG. 5 depicts a simplified flowchart of a method for performing a personalized search according to one embodiment of the present invention.

FIG. 6 depicts an embodiment of an interface showing personalized search results according to one embodiment of the present invention.

FIG. 7 depicts an interface according to one embodiment of the present invention.

### DETAILED DESCRIPTION OF THE INVENTION

Embodiments of the invention will now be described, by way of example, not limitation. It is to be understood that the invention is of broad utility and may be used in many different contexts.

The example of a search process as described herein below can be modeled by a searcher presenting to a search system a query and receiving a response (search results) indicating the one or more “hits” found. A query can be in the form of a search query string comprising one or more tokens delimited by delimiters or parsing rules. In addition to varying a search based on variations of the search query string, context might be also taken into account. For example, the querier might have previously set constraints on the search, such as to return only age-appropriate hits, prior searches might be taken into account, and a querier identity (such as the Yahoo! ID currently associated with the Web browser client submitting the search query string) and settings set by the user.

When a query is received by a search system, it processes the search and returns one or more “hits”, where a “hit” is the atomic unit handled by the search system. For example, where the search system manages a structured database, the hits are records from the structured database. Where the search system manages documents, such as text documents, image and text documents, image documents, HTML documents, PDF documents, or the like, the atomic unit is the document. It should be understood that the present invention is not limited to any particular atomic unit, but by way of example, much of this disclosure describes searching using the document as the atomic unit. Furthermore, a structured database is not required.

A hit is an atomic unit that the search system identifies as matching criteria defined by the query. It should be understood that the search system need not provide all hits or only hits that match the query. For example, the search system might limit the number of hits returned to some number, might apply other limitations to the query term, such as omitting hits that match the query, ignore duplicate hits, etc. The search system might also expand the search results to include hits that almost match the query, hits that are designated to be included in searches, such as special topic hits, advertising hits, etc. Some expansion or contraction might be dependent on the size or content of the search results prior to such expansion or contraction. For example, the search engine might add hits that are close if no hits would otherwise be returned and might remove hits if too many hits would have been returned, such as by deleting common words from queries prior to completing the search results.

A searcher can be a human user, such as a person typing in search terms into a browser window to query a search engine via the Web, but can also be an automated process, such as a computer program capable of sending queries to search engines in the form expected by the search engine. For example, a computer program might generate queries and form HTTP messages directed at a Web server coupled to a search engine.

In many of the examples shown herein, the search engine searches among a set of documents for documents (hits) that match the criteria defined by the query. It should be understood that the term “document” is generally used to refer to units of the corpus being searched. A document can be a document, such as a contract, a file, a story, writing, or the like, but might also be a snippet of text, data that might be considered part of a document in other contexts, program code, image data, a stored file, or the like. Therefore, the term need not be narrowly construed.

In searching, the search engine might pull from all available documents it has indexed, but the search engine might instead limit the search to documents within one or more subdomains, where a subdomain is a previously designated proper subset of all the documents available to the search engine. In some instances, a subdomain might be further subdivided into smaller subdomains.

One example of a subdomain may include information that is specific to a user or entity. For example, user-specific information may be a user's calendar information, location information for a user, a user's address book, etc. This information is information that has been stored for a user. Conventionally, when a query is received, generic information, such as indexed Web content or other content not specific to a user, is searched. However, in embodiments of the present invention, a user's personal information may be searched in addition to or in lieu of performing a generic search. Thus, a user may be provided personal information in response to submitting a search query. One example is when a search query for “Dentist” is received from a user. A user's calendar may be searched for dentist appointments and any appointments for a dentist in a user's calendar are returned.

Referring now to the figures, an exemplary search system will now be described.

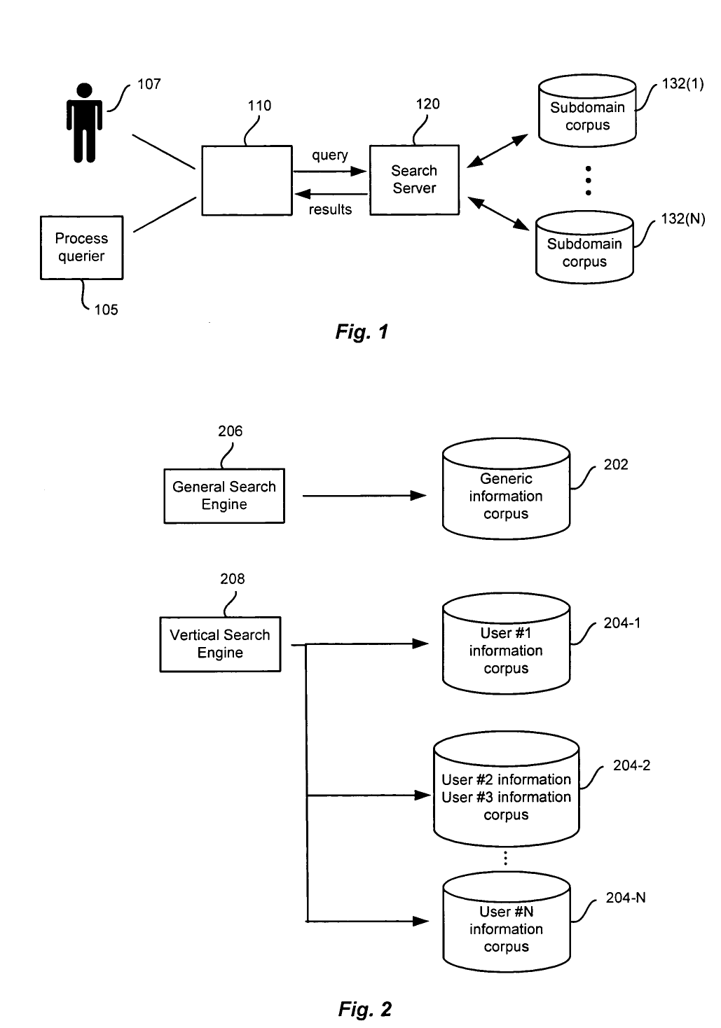

FIG. 1 is a block diagram of a search system 100 according to embodiments of the present invention. Using search system 100, a querier issues a search request to a search server using a search client, such as a Web browser client. As shown in FIG. 1, a human user 103 or a computer process 105 issues a query using search client 110. The search query, typically in the form of a search query string, is sent to a search server 120, which returns search results responsive to the search query to search client 110. In other variations, the search query comes from one system and the results are routed to another system.

Search server 120 is shown coupled to several subdomain corpora 132. It should be understood that, for storage efficiency or other reasons, the content or information of the subdomain corpora might overlap such that some content or information is present in more than one subdomain corpus. Throughout this disclosure, where there are multiple instances of an object and the number of instances is not critical, the instances are numbered from “1” to “N” with the understanding that the value of N need not be identical from use to use, unless otherwise indicated. For example, N is used as the number of subdomains, but that number might vary from example to example. It should also be understood that nothing here requires that all instances be used.

The interconnections between various systems need not be described in detail, as such methods of interconnections can be accomplished using well-known techniques. For example, search client 110 might be a personal computer running an HTTP client, such as a Web browser client, and communicating with an HTTP server running at search server 120, interconnected over a network such as the global Internet. It should be understood that other embodiments also fall within the scope of the invention. For example, search client 110 might be implemented as a handheld device, a computer with no human user interface, a dedicated device, a kiosk, etc. Also, the clients and servers need not use HTTP, but might use a different protocol for making requests for pages and objects and for responding to those requests.

In operation, and as described in further detail below, search client 110 sends a search query string to search server 120, possibly also including a user identity of the user sending the request. The user identity includes information that identifies a user or may be used to identify a user. For example, the user identity may be a user ID, such as a Yahoo! ID, account name, email address and the like. With the user identity, search server 120 might look up a user specification for the identified user and use that to perform the search. The user specification may include user preferences, information about the user, search preferences, etc. Search server 120 parses and analyzes the search query string to determine if a subdomain search is appropriate, then sends the query to the appropriate subdomain(s) and/or performs a general search. In one embodiment, a user's personal information in a subdomain is searched.

FIG. 2 depicts various search engines and corpora that may be included in embodiments of the present invention. As shown, a general information corpus 202 and one or more user information corpora 204(1)-204(N) are included. Additionally, a general search engine 206 and a vertical search engine 208 are provided. Although a single general search engine 206 and a single vertical search engine 208 are provided, it will be understood that any number of general and vertical search engines may be used. For example, a first vertical engine 208 may search corpus 204(1) and a second vertical search engine 208 may search corpus 204(2). Moreover, vertical search engines may search generic information corpus 202 and general search engine 202 may search user information corpora 204. Also, there may be multiple generic information corpora 202 or information in user information corpora 204 may be aggregated. Thus, all components depicted in FIG. 2 may be scalable or aggregated.

Generic information corpus 202 includes generic information that may be searched by all users. For example, generic information corpus 202 may include information, such as indexed web content, content that has been organized into specialized areas, etc. In one embodiment, this content is information that may be searched by any user by submitting a generic query. Some of this generic information might be organized or filterable by user demographics.

User-specific corpora 204 include information that is specific to users. In one embodiment, information specific to a user is information that is personal or unique to a user, or a group of users. For example, calendar information found in a user's calendar is user-specific information. When the term “user” is used, it will be understood that any number of users or entities may be specific to that information. For example, a corporation, client, server, etc. may be associated with user-specific information.

As shown, user-specific information corpus 204(1) includes information specific to a user #1, user-specific corpus 204(2) includes information specific to a user #2 and a user #3, and user-specific corpus 204(N) includes information specific to a user #N. User-specific information corpora 204 may include information for a single user or multiple users. In one embodiment, the user-specific information is only accessible by the user associated with the information.

User-specific information may be indexed based on user identities. A user identity includes any information that may be used to determine a user. For example, a user identity may be a username, login name, account number, etc. The user identity may be used to index information. Also, an identifier associated with the user identity may be used to index information. For example, the identifier may be an index into a corpus 204 where user information is stored. Thus, information specific to a user may be accessed when a user identity is determined. The user-specific information may be referred to as user identity information.

In one embodiment, information in user-specific corpora 204 is stored on the server side, i.e., behind search server 120. This means that the user information is stored remotely from the user. However, it will be understood that certain aspects of user identity information may also be stored on the client-side. In one embodiment, user-specific corpora 204 are maintained by an entity that is associated with general engine 206 and/or vertical engines 208. For example, Yahoo! may maintain user identity information for various users on servers controlled by Yahoo!. Thus, when a search is received, a Yahoo! server may perform a search with the user identity information that is accessible to the Yahoo!. In some variations, users might install an indexing agent/search application locally. The indexing agent would catalog the user's own locally stored corpora. Then, the search application could allow them to search both local corpora (via the indexing agent) and hosted corpora simultaneously, presenting unified results for perusal. The indexing agent running on the user's own computer might communicate with the servers and allow the user to search their own corpora remotely (for example, from a public terminal). Advantages to storing information on the server-side include high availability, data protection, and speed of search. In most situations, however, users may still maintain local workspaces.

General search engine 206 and vertical search engine 208 are configured to access generic information corpus 202 and user-specific information corpora 204, respectively. In one embodiment, general engine 206 and/or vertical search engine 208 are part of search server 120 or may be separate search engines. For example, search engines 206 and 208 may be controlled by a different entity than the entity that received the search query. Search server 120 may then communicate with the search engines to perform the search. In this case, user identity information may be stored remotely from search server 120.

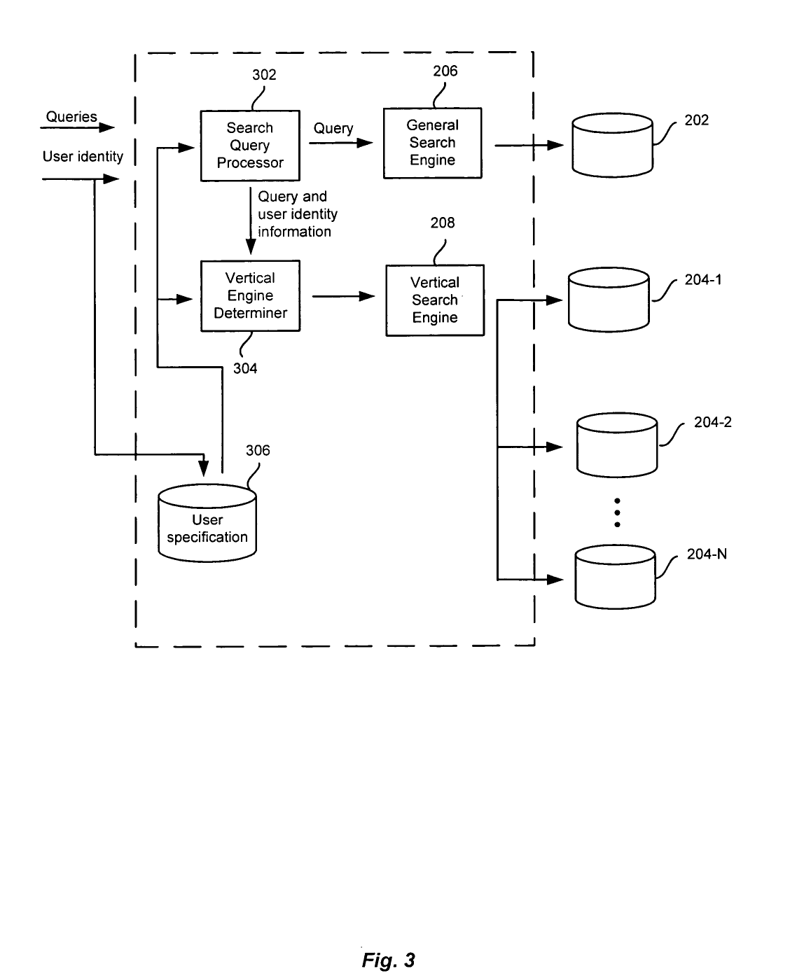

FIG. 3 depicts an embodiment of search server 120 according to embodiments of the present invention. As shown, search server 120 includes a search query processor 302, a vertical engine determiner 304, and a user identity 306. Also, search server 120 includes general search engine 206 and vertical search engine 208 but it will be understood that these engines may be part of other systems.

Search query processor 302 receives a query from a client 107 or process querier 105. In one embodiment, the query is a string that specifies the search terms. In addition, a user identity may also be received. For example, a user may enter in a user ID or any other identification information or be logged on in some way that indicates a user identity to the server such that user history, preferences, demographics, etc. can be associated with the query. Also, information may be automatically received, such as through a cookie or any other means. The user identity is used to identify a user and may also be used to determine user identity information specific to the user identified by the user identity. For example, information may be indexed in a database. The user identity may be used to determine information in the database that is associated with the user identity and thus the user.

Search query processor 302 is configured to determine user identity information from database 306. For example, a user identity may be received and then information associated with the user identity in database 306 is determined and searched. For example, a user identity may be used to retrieve a user specification that indicates preferences or user identity information that should be searched based on certain searches that are performed. For example, a user may prefer that calendar appointments and email archives be searched when a search query is received. A user specification might include options chosen by the user that would govern the corpora searched as well as serve to filter the results returned by the search engine when a query was received. For example, the user specification might include settings such as “Search Calendar? [yes or no]”, “How far back to search your Calendar? [week, 1 month, 1 year, a specific date range, or all dates]”, “Search Address Book? [yes or no]”, etc.

Based on the query and/or user identity, search query processor 302 determines if a personalized search should be performed. For example, if a user has not logged in or user identity has not been received, a search of user identity information specific to a user may not be performed. For example, a search query may be received in a generic search object entry and a personal search may be automatically performed. In this case, a user may be prompted to enter a user identity in order for a personalized search to be performed. If the user identity information is received, search query processor 302 may determine that a personalized search should be performed. For example, a search of personalized user identity information may always be performed if the user identity has been determined. In another embodiment, the user identity may be used to determine if a personalized search should be performed or not. The user specification might hold variables governing which corpora to search and how. The user might be allowed to override his/her user specification. For example, in a query, a user might express explicitly that he/she wanted to search his/her Calendar, even if his/her user specification indicated otherwise. Also, search query processor 302 may determine if a search of generic information corpus 202 should also be performed. The search of generic information corpus 202 may be performed in addition to performing a personalized search. Moreover, searches of other corpora may be performed, such as a subdomain search using specialized information.

If a personalized search should be performed, the query and user identity information are sent to vertical engine determiner 304. Vertical engine determiner 304 is configured to determine a vertical search engine 208 to which the query will be sent, based on the different user-specific corpora 204 that may be searched using the engine. In one embodiment, information specific to one user may be located in one user-specific information corpus 204 or a multiple user-specific information corpora. Thus, an engine assigned to search the corpora with the user identity information is determined. It will be recognized that any number of vertical search engines 208 may be selected.

Accordingly, using the query and user identity, vertical engine determiner 304 determines which vertical search engines 208 should be used if more than one vertical search engine 208 is available, an engine 208 may be selected by round robin or other load balancing methods. Also, vertical search engines 208 may be associated with subsets of users.

The selected vertical search engine 208 receives the query and determines information specific to the user identity in user-specific information corpus 204. That information is searched using a query to generate search results. For example, information may be indexed by an identifier, which is used to determine the user identity information.

Accordingly, search results that include user identity information are generated. Additionally, if a general search was performed with general information corpus 202, the two search results may be combined and outputted to a user.

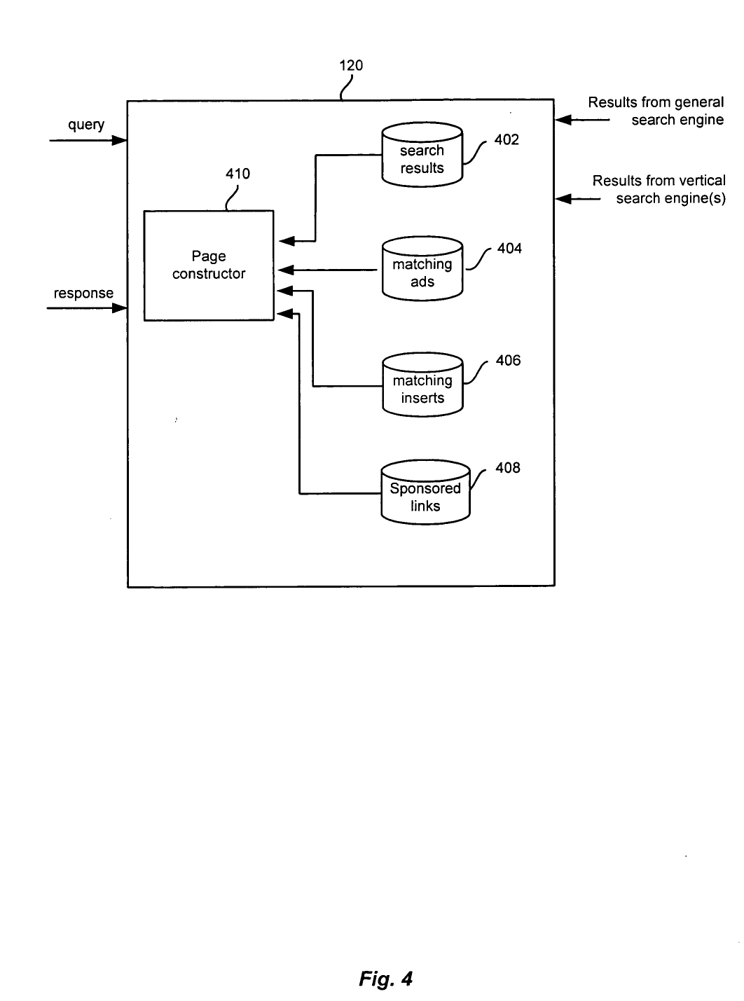

FIG. 4 depicts a block diagram of elements that might be used to generate a response to a query according to one embodiment of the present invention. Search server 120 includes a matching ads database 404, a matching inserts database 406, and a sponsored links database 408. Search server 120 obtains search results 402 that have been generated from general search engine 206 and one or more vertical search engines 208. The search results may be combined with information for matching ads 404, matching inserts 406, and sponsored links 408.

A page constructor 410 determines which search results and which additional information should be included in a page to send to a client in response to a query. In one embodiment, page constructor 410 may use the query to determine which information for matching ads 404, matching inserts 406, and sponsored links 408 to include in a page. Additionally, other information, such as a user identity or user identity information may be used to determine the information to be included in the page. Information in the user specification, search results, or user identity information may be used. In one example, a user's zip code may be used to determine matching ads from a user's geographical location.

Page constructor 410 then formats results from the general search engine 206 and vertical search engine 208 in a page along with the additional information. In one embodiment, links to the search results are provided where a link may be selected by a user. The link then causes a page or document to be retrieved and displayed. Additionally, the link may cause an additional search to be performed. For example, vertical search engine 208 may be accessed and a search performed.

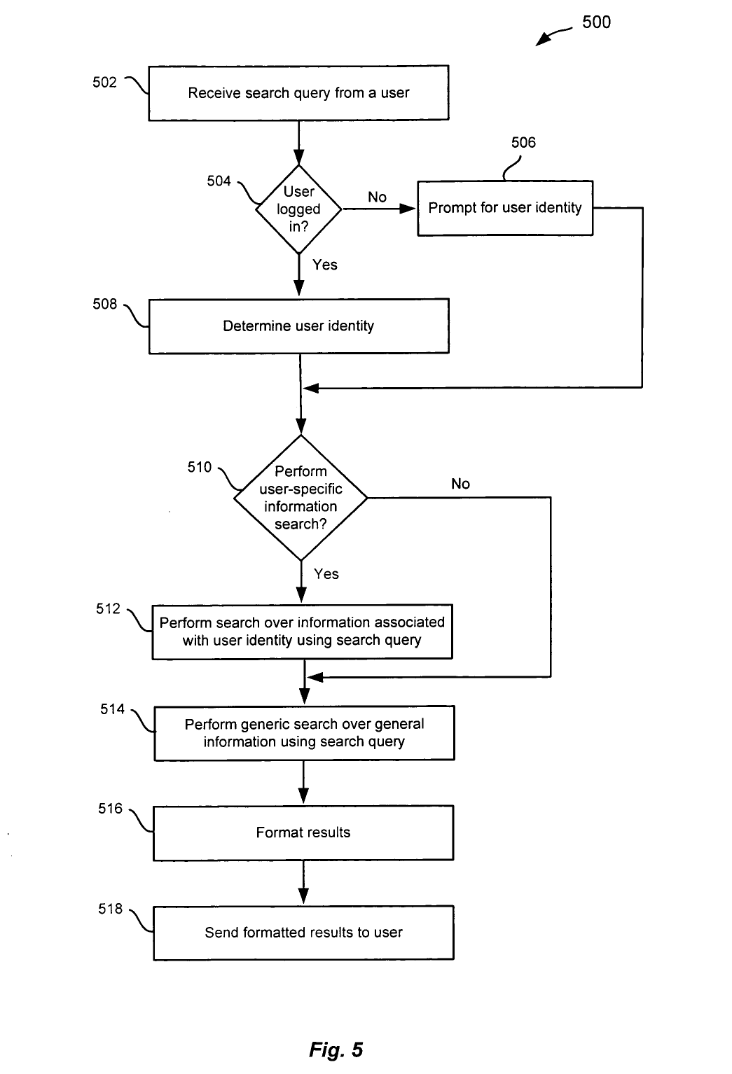

FIG. 5 depicts a simplified flow chart 500 of a method for performing a personalized search according to one embodiment of the present invention. In step 502, a search query is received from a user. In step 504, it is determined if the user has logged in. For example, the user may log in by entering a user identity and password. Additionally, the user may have previously logged in or the user identity may have been received using a cookie or any other method.

If the user has not logged in, in step 506, the user is prompted to enter a user identity. For example, a web page or window may be outputted that includes entries for a user identifier and a password. The process then proceeds to step 510, described below.

In step 508, if the user has logged in, the user identifier is determined. For example, the user identifier may be received from a cookie sent by a client system of the user.

In step 510, it is determined if the personalized search should be performed. User preferences associated with the user identity may be used to determine if a user-specific search be performed. Also, a query may be used to determine the user identity information. For example, if it is known that the user does not have any information stored that may satisfy a query, then a search of user identity information may not be performed. Also, a query for a dentist appointment may only be performed using a user's stored calendar information.

If a personalized search is not going to be performed, the process proceeds to step 514, described below. If a personalized search should be performed, in step 512, a search is performed using information associated with the user using the search query. The information searched is unique to a specific user. For example, information may have been received from multiple users. That information is stored by an entity that is performing the search. Information is specific to each user and is secured in that all users cannot access another user's information. If a search is received for a user identity, information associated with that user identity is searched.

In step 514, a generic search may be performed over generic information using the search query. In one embodiment, a generic search may not be necessary but may also be performed to provide a user with general generic search results in addition to user identity search results. In one embodiment, a search and query received in step 502 may have been received in a generic search query object entry and intended for a search to be performed over generic information. However, search server 120 may determine that a search over user identity information may be useful. Thus, a search performed in step 512 is also performed without any additional user input indicating that a search over that user's information should be performed.

In step 516, the results are formatted. For example, the general information search results and personalized information search results may be combined into a single page. Additionally, matching ads, links, and inserts may also be added. The matching ads, links, and inserts may be determined based at least upon the query and/or the user information searched. For example, if a search query of dentist is received, a search for dentists in information specific to a user may be performed. In one case, an appointment for a certain dentist may be retrieved from the user's calendar information. Ads for dentists that are in the same area as this dentist may then be inserted in the web page.

In step 518, the formatted results are sent to a user. In one embodiment, the results are sent to a client that sent the search query or the results may be sent to an email address or other contact addresses associated with the user identity are determined.

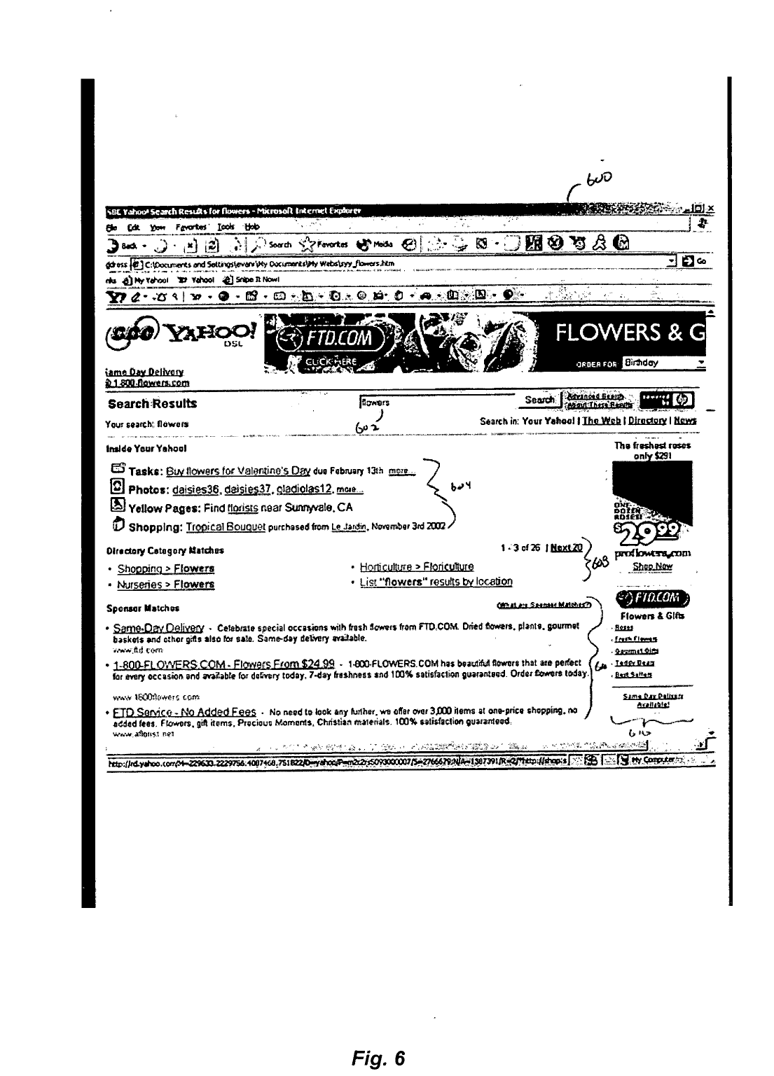

FIG. 6 depicts an embodiment of an interface 600 showing personalized search results according to one embodiment of the present invention. As shown, a search query “flowers” was entered in a search query entry 602. Entry 602 may be a dialog box for a generic search. In another embodiment, the user may have specified that a search should have been done using user identity information for the user. For example, a tab or link (e.g., Your Yahoo!) that indicates a personalized search should be performed is provided.

As shown, personalized results are returned in a layout 604. In one example, information stored as tasks for a user is searched and the task “Buy Flowers for Valentine's Day” is returned. Also, information in photos that include flowers are also determined and returned. Also, information for shopping specific to a user is searched and it is determined that a tropical boutique was purchased by the user from Ray Jardin on Nov. 3, 2002. Accordingly, items previously bought on-line are searched.

User identity information was also used to return other search results. For example, a user location of Sunnyvale, Calif. is determined and a link for florists in that area is returned.

A generic search was also performed and the search results are shown in a layout 608. As shown, categories for flowers were found. The categories may correspond to different corpora of specialized information. Accordingly, a generic search and personalized search is performed when a search query is received. In one embodiment, a personalized search may have been specified and a generic search is automatically performed in addition to the personal search. Also, a generic search is specified and a personalized search is also automatically performed in addition to the generic search.

Sponsored matches in a layout 608 are shown in addition to matching ads in a layout 610. The sponsored matches and matching ads are related to at least the search query that was received or user identity information (e.g., the stored user-specific information). For example, suppose a user has shopped and previously purchased flowers, search server 120 may determine that a user is looking for a flower service and thus matching ads and sponsored matches for florists are also returned with the search results for a query of “flowers.”

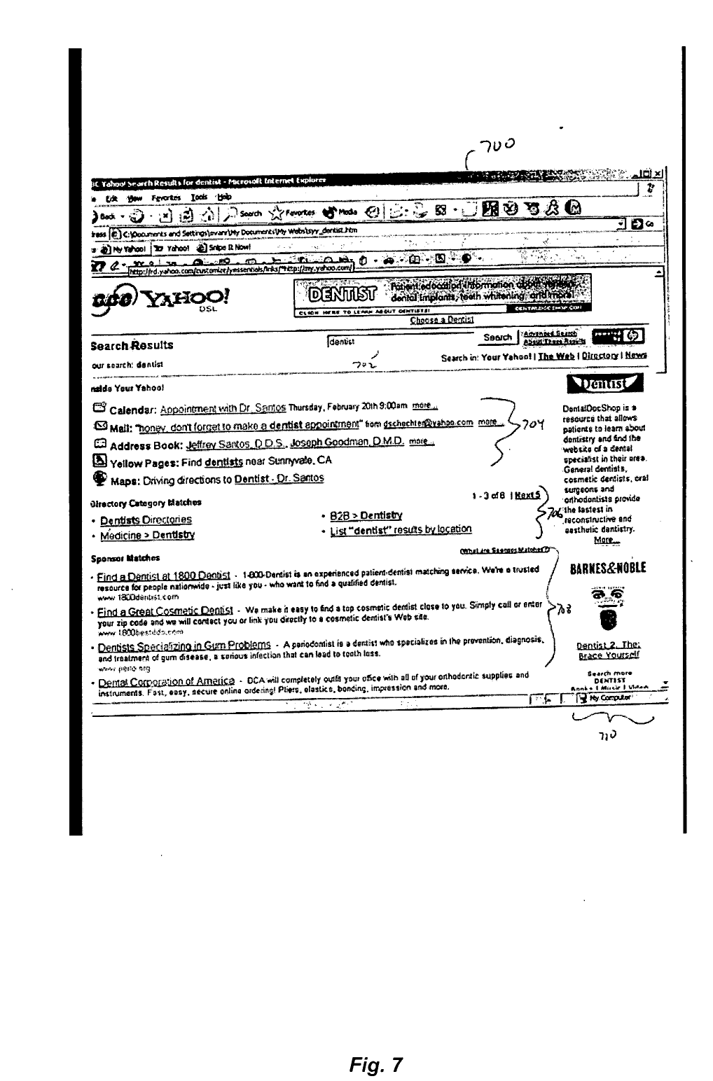

FIG. 7 depicts an interface 700 according to one embodiment of the present invention. As shown, a search query of “dentists” has been entered in an entry 702. Information that is specific to a user is searched and search results are outputted in a layout 704. As shown, information in a user's calendar is searched and an appointment with a dentist Dr. Santos is found. Also, information in stored emails is searched and an email about a dentist appointment is found. Also, address book information is searched to determine information for different dentist's addresses. Thus, information associated with the user is searched and any relevant information for the search query is returned.

Also, location information associated with a user, such as Sunnyvale, Calif., is used to return a link to dentists in that location. Also, an appointment with Dr. Santos retrieved using user identity information is used to return a link to driving directions for that dentist. Accordingly, a search through user identity information yielded a first result and then a second search using that search result was performed to yield a second search result using the user identity information.

Additionally, a generic search was performed and search results in a layout 706 are returned. These results include results for searches using the query “dentists”.

Sponsored matches are shown in a layout 708 and matching ads are shown in a layout 710. Sponsored matches 708 may be related to the search query and/or user identity information.

Matching ads 710 also include dentist-related subjects. For example, an ad for a bookstore advertising a dentist-related book and a dentist-related website are also provided. Matching ads 710 may also be related to the search query and/or user identity information.

Accordingly, embodiments of the present invention receive a search query and determine information that is specific to a user. The information specific to a user is searched and used to generate personalized search results. Accordingly, a user may search information that has been stored for that user. In one embodiment, the user does not have to specify that a personalized search should be performed. A search server may intelligently determine that user identity information should be searched. Additionally, a generic search may also be performed and thus generic search results and user-specific search results may be returned.

Accordingly, embodiments of the present invention provide a personalized search experience. The most pertinent information for a search query may be found in user identity information. Also, with the proliferation of portals, the searching of user identity information stored by the portals becomes increasingly important. The most relevant searches may be performed using the user identity information.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A method for performing a personalized search, the method comprising:
receiving a search query;
determining a user identity associated with the search query, wherein a user-specific search includes a search of information specific to a user identified by the user identity;
determining if a user-specific search should be performed;
performing a search using the search query with user identity information to generate user-specific search results specific to the user identified by the user identity,
wherein the user-specific search results include information that is specific to the user identified by the user identity associated with the received search query.

2. The method of claim 1, further comprising performing a search with generic information to generate generic search results using the search query.

3. The method of claim 2, wherein the generic search results comprise information found in the World Wide Web (WWW).

4. The method of claim 2, further comprising combining the generic search results and the user-specific search results.

5. The method of claim 1, further comprising outputting the user-specific search results.

6. The method of claim 1, wherein the search query is received in a generic search query object, wherein determining if the user-specific search should be performed is decided automatically based on the user identity.

7. The method of claim 6, further comprising:
determining at least one of matching ads, matching inserts and sponsored links for the user-specific search results; and
adding the determined at least one of matching ads, matching inserts and sponsored links for the user-specific results to the outputted user-specific search results.

8. The method of claim 1, wherein the user identity information comprises information stored remotely from the user.

9. The method of claim 1, wherein the user identity information comprises information that is maintained by an entity that performed the search.

10. The method of claim 1, wherein the user identity information is determined based on the user identity.

11. The method of claim 1, wherein the user identity is received from the user.

12. The method of claim 1, wherein the user identity comprises a user specification of user preferences.

13. The method of claim 1, further comprising determining the user identity based on information specific to the user.

14. The method of claim 1, further comprising:
using the user-specific search results to perform a second search to generate second search results.

15. A method for performing a search, the method comprising:
receiving a search query from an entity;
determining if a search using information specific to the entity should be performed;
determining information that is specific to the entity associated with the search query;
searching the determined information using the search query to generate search results that include at least a part of the determined information; and
outputting the determined search results.

16. The method of claim 15, further comprising:
determining an entity identity for the entity; and
using the entity identity to determine the information for the entity.

17. The method of claim 15, further comprising:
receiving information for the entity; and
storing the information remotely from the entity.

18. The method of claim 15, further comprising:
receiving information from a plurality of entities; and
storing the information remotely from the plurality of entities,
wherein determining information that is specific to the entity comprises determining the information from the stored information for the plurality of entities.

19. The method of claim 15, wherein the search query is received in a generic search query object, wherein determining if the search using entity-specific information should be performed is decided automatically based on an entity identity.

20. A search apparatus configured to perform a personalized search, the apparatus comprising:
one or more search engines;
one or more corpora of information, wherein user-specific information is included in the one or more corpora of information;
a search server configured to receive a search query, the search server comprising:
a search determiner configured to determine if a personalized search of user-specific information should be performed;
a search engine determiner configured to determine a search engine in the one or more search engines to perform the personalized search,
wherein the search engine is configured to determine the user-specific information for the entity in a corpus of the one or more corpora and to perform a search using the search query with the determined user-specific information to generate user-specific search results.

21. The search apparatus of claim 20, further comprising:
a page constructor configured to output the user-specific search results.

22. The search apparatus of claim 21, further comprising:
a database of at least one of matching ads, matching inserts and sponsored links for the user-specific results, wherein the page constructor is configured to include t at least one of matching ads, matching inserts and sponsored links for the user-specific results to the outputted user-specific search results.

23. The search apparatus of claim 20, wherein the one or more search engines comprise a generic search engine configured to perform a generic search using the search query to generate generic search results.

24. The search apparatus of claim 23, wherein a page constructor is configured to include the generic search results and user-specific search results together.

25. The search apparatus of claim 20, wherein the one or more corpora include user-specific information that is identified using a user identity.
